(19) United States
(12) Patent Application Publication
(10) Pub. No.: US 2004/0160333 A1
(43) Pub. Date: Aug. 19, 2004

(54) Attention getting device

(76) Inventor: Clyde Bruce Elliott, Riverside, CA (US)

Correspondence Address: John G. Chupa, Law Offices of John Chupa & Associates, P.C., Suite 50, 28535 Orchard Lake Road, Farmington Hills, MI, 48334, US

(21) Appl. No.: 10/779,981

(22) Filed: Feb. 17, 2004

(30) Foreign Application Priority Data
Feb. 19, 2003 (TW) 092202584

(51) Int. Cl. G08B 5/00

(52) U.S. Cl. 340/815.4; 340/331; 116/202; 40/299.01

(57) ABSTRACT

The present invention provides a attention getting device, which comprises: a standing board, having a standing surface; a flashing element, having a twinkling light body outwardly and having a circuit connected to a battery behind said twinkling light body and inside said flashing element, and having a back cover which is made of ferrous material; and a magnet with magnetism; thereby, said flashing element can twinkle and mutually attract with said magnet on a back surface and said standing surface of said standing board respectively so as to attract the attention and vision of the people.

### FIELD OF THE INVENTION

The present invention relates generally to an attention getting device. More particularly, the present invention relates to an attention getting device that has a flashing element positioned inside a light body for twinkling and getting attention.

### BACKGROUND OF THE INVENTION

Generally, the message conveying, leaving a small message to leaving a big message as a promotional advertisement, is very important in our day-to-day livelihood. Basically, the message conveying is used to convey specific message.

One of the previous message leaving device prior arts can often be seen in office or home, which has a magnet attracted to a metal object to clip the message; to while the promotional advertisement, such as desk-top promotional advertisement, is displayed on a surface of an object that vertical or non-vertical stands on a table or a counter.

However, the two previous leaving message device prior arts have some drawbacks, such as when the promotional advertisement is positioned front some promotional advertisement with similar information such as the counter of a travel agency, it is impossible to highlight the specific information of the promotional advertisement. Furthermore, in many noisy places, such as coffee shop or restaurant, the guest must use an exaggerated gesture to request some certain services form the attendants.

Therefore, it needs an attention getting device that has a flashing element positioned inside a light body for twinkling and getting attention.

### SUMMARY OF THE INVENTION

To solve the above problems, it is an object of the present invention to provide an attention getting device, which has a flashing element positioned inside a light body for twinkling and getting attention.

To accomplish the above object of the present invention, there is provided an attention getting device, which comprises: a standing board, having a standing surface; a flashing element, having a twinkling light body outwardly and having a circuit connected to a battery behind the twinkling light body and inside the flashing element, and having a back cover which is made of ferrous material; and a magnet with magnetism; thereby, the flashing element can twinkle and mutually attract with the magnet on a back surface and the standing surface of the standing board respectively so as to attract the vision of the people.

The novel features of the invention are set forth with particularity in the appended claims. The invention will be best understood from the following description when read in conjunction with the accompanying drawings.

### BRIEF DESCRIPTION OF THE DRAWINGS

FIG. 1 shows a disassembled view of an attention getting device in accordance with one embodiment of the present invention.

FIG. 2 shows an assembled view of an attention getting device in accordance with one embodiment of the present invention.

FIG. 3 shows an assembled view of an attention getting device in accordance with another one embodiment of the present invention.

### DESCRIPTION OF THE PREFERRED EMBODIMENTS

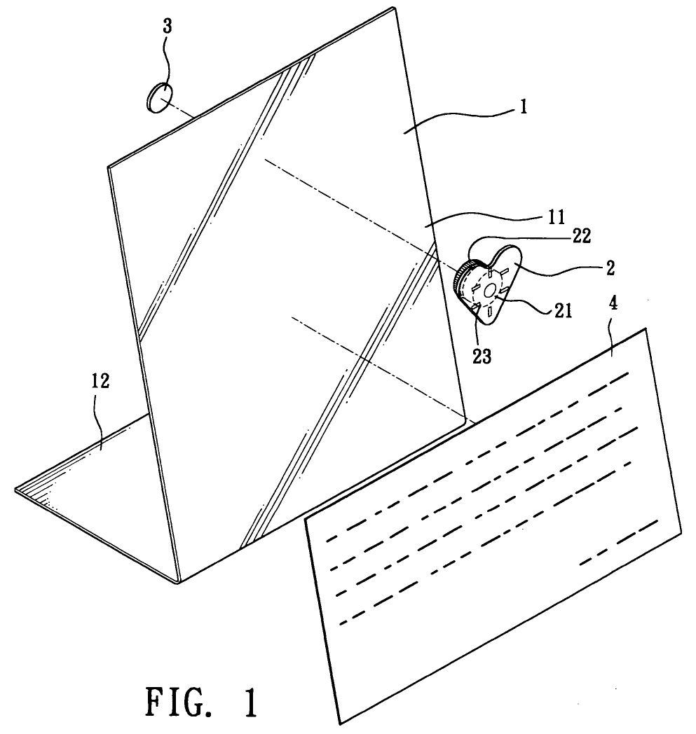

Referring to FIG. 1 shows a disassembled view of an attention getting device in accordance with one embodiment of the present invention. As shown in FIG. 1, basically, the attention getting device of the present invention comprises: a standing board 1; a flashing element 2; a magnet 3 and/or a message 4.

Wherein, the standing board 1, for example but not limited be made of transparent material, has a standing surface 11, basically. The standing surface 11 of the standing board 1 can vertically or non-vertically stands on a position surface. As shown in one embodiment of the present invention, the standing surface 11 and the bottom plate 12 are for example but not limited be formed by bending method. However, embedding the standing surface 11 in the bottom plate 12 also can form it.

Wherein, the flashing element 2 had at least one light body 21 is a prior art, and has the twinkling function. During practice, the flashing element 2 can be a LED and driven by a battery. Meanwhile, the rear side of the flashing element 2 can be covered by a back cover 22 made of the ferrous material for screwing and covering the body 23 of the flashing element 2. Furthermore, the light body 21 is turned on by screwing tightly the back cover 22 to said body 23 and turned off by screwing loosely said back cover 22 to said body 23.

Due to the magnet 3 has magnetism; therefore, the magnet 3 can mutually attract to the back cover 22 of the flashing element 2.

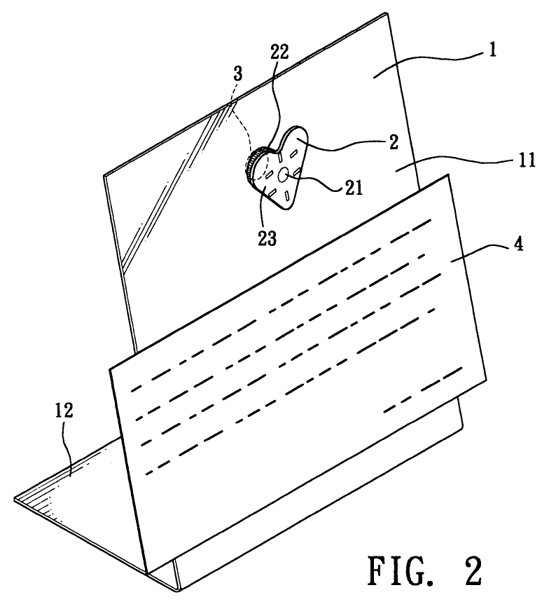

Referring to FIG. 2 shows an assembled view of an attention getting device in accordance with one embodiment of the present invention. As shown in FIG. 2, during practice, the magnet 3 and the back cover 22 of the flashing element 2 can be respectively positioned on both sides of the standing surface 11 for fastening by the mutually magnetism attracting. While the light body 21 of the flashing element 2 twinkling, the attention getting device can get the attention of the people. If the attention getting device wishes to convey a message, the message 4 with conveyed message can be stood on the standing surface 11 by gluing the rear side of the message 4 to the standing surface 11, or clip the message 4 between the flashing element 2 and the magnet 3 to form a fasten status.

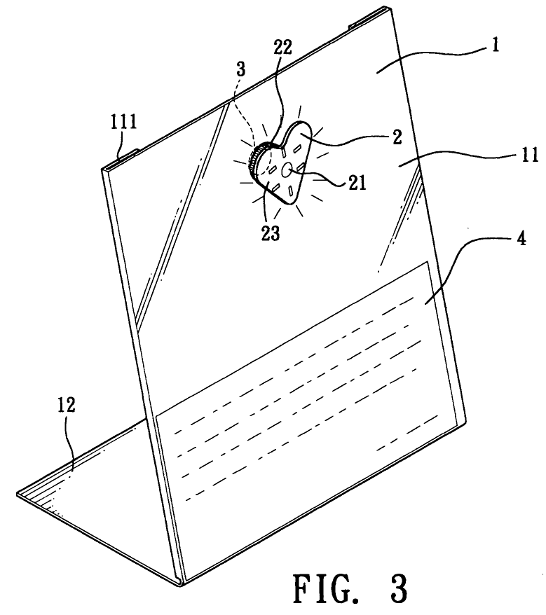

Referring to FIG. 3 shows an assembled view of an attention getting device in accordance with another one embodiment of the present invention. As shown in FIG. 3, the both sides of the standing surface 11 also can be bent backwardly and then bent centrally to form a notch 111, and the standing surface 11 is made of transparent material such as acrylic plastic. Therefore, the message 4 can be inserted into the notch 111 and formed fixing positioned behind the standing surface 11. Thus, the user can get the message from the transparent standing surface 11 and get the attention by the twinkling of the flashing element 2.

While the invention has been described with reference to a preferred embodiment thereof, it is to be understood that modifications or variations may be easily made without departing from the spirit of this invention, which is defined by the appended claims.

What is claimed is:

1. An attention getting device, which comprises:
a standing board, having a standing surface;
a flashing element, having a twinkling light body outwardly and having a circuit connected to a battery behind said twinkling light body and inside said flashing element, and having a back cover which is made of ferrous material; and
a magnet with magnetism;
thereby, said flashing element can twinkle and mutually attract with said magnet on a back surface and said standing surface of said standing board respectively so as to attract the attention and vision of the people.

2. An attention getting device as claimed in claim 1, it further comprises a message element connected to said standing surface for conveying message.

3. An attention getting device as claimed in claim 1, wherein both sides of said standing surface of said standing board can be bent backwardly and then bent centrally to form a notch for positioning said message, wherein, said standing board is made of transparent material, preferably.

4. An attention getting device as claimed in claim 1, wherein said flashing element is turned on by screwing tightly said back cover to said body and turned off by screwing loosely said back cover to said body.
